(19) United States
(12) Patent Application Publication
(10) Pub. No.: US 2023/0177972 A1
(43) Pub. Date: Jun. 8, 2023

(54) Proficiency Detection Method and Proficiency Detection System Capable of Detecting Learning Proficiency of a User According to a Handwriting Response Status and a Proficiency Score

(71) Applicant: BENQ CORPORATION, Taipei (TW)

(72) Inventor: Po-Chun Huang, Taipei (TW)

(73) Assignee: BENQ CORPORATION, Taipei (TW)

(21) Appl. No.: 17/690,020

(22) Filed: Mar. 9, 2022

(30) Foreign Application Priority Data
Dec. 6, 2021 (TW) 110145454

(51) Int. Cl. G09B 7/04; G06V 40/16

(52) U.S. Cl. CPC G09B 7/04; G06V 40/161; G06V 40/171; G06V 40/174

(57) ABSTRACT

A proficiency detection method includes providing a question to a user, setting a scoring standard, detecting a handwriting response status of the user to the question, generating a proficiency score according to the handwriting response status and the scoring standard, and determining a proficiency of the user according to the proficiency score.

### BACKGROUND OF THE INVENTION

### 1. Field of the Invention

The present invention illustrates a proficiency detection method and a proficiency detection system, and more particularly, a proficiency detection method and a proficiency detection system capable of detecting learning proficiency of a user according to a handwriting response status and a proficiency score.

### 2. Description of the Prior Art

With the rapid development of technologies, blackboards or whiteboards used for traditional teaching courses have been gradually eliminated. In recent years, electronic whiteboards and remote teaching interfaces have gradually become major student learning platforms. The electronic whiteboards can be used in a teaching technology field. Further, since the electronic whiteboards include a plurality of sensors, such as touch sensors or elements, the electronic whiteboards can digitize learning statuses of students when they answer questions. Therefore, teachers can collect information of the learning statuses of the students. In other words, the teachers can use the electronic whiteboards for generating the questions to the students for tracking their learning effectiveness. Further, after the students answer the questions, the proficiency of the students can be provided to their teachers or parents. Particularly, the proficiency of the students can be regarded as an important indicator for tracking their learning effectiveness.

Currently, there is no quantitative method of the electronic whiteboards or remote teaching interfaces for detecting and analyzing the learning proficiency of the students. Their teachers may only determine the learning proficiency or learning effectiveness according to their test scores. However, it is not objective to determine the learning effectiveness of the students according to their test scores. For example, when a student has a bad day, the student may not perform as well in the test. Therefore, it is important to develop a method for quantizing the learning proficiency of the students for tracking their learning effectiveness accurately through the electronic whiteboards and the remote teaching interfaces.

### SUMMARY OF THE INVENTION

In an embodiment of the present invention, a proficiency detection method is disclosed. The proficiency detection method comprises providing a question to a user, setting a scoring standard, detecting a handwriting response status of the user to the question, generating a proficiency score according to the handwriting response status and the scoring standard, and determining a proficiency of the user according to the proficiency score.

In another embodiment of the present invention, a proficiency detection system is disclosed. The proficiency detection system includes at least one input/output unit configured to display a question and generate interactive data, an input/output integration unit coupled to the at least one input/output unit and configured to receive and integrate the interactive data, a storage unit configured to save data, and a processor coupled to the storage unit and the input/output integration unit. The processor provides the question to a user through the at least one input/output unit. The processor sets a scoring standard. The at least one input/output unit detects a handwriting response status of the user to the question. The at least one input/output unit transmits information of the handwriting response status to the input/output integration unit. The processor generates a proficiency score according to the handwriting response status and the scoring standard through the input/output integration unit. The processor saves information of the handwriting response status to the storage unit. The processor determines a proficiency of the user according to the proficiency score.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a proficiency detection system according to a first embodiment of the present invention.

FIG. 2 is a block diagram of a proficiency detection system according to a second embodiment of the present invention.

FIG. 3 is an illustration of display regions of an electronic whiteboard of the proficiency detection system in FIG. 2.

FIG. 4 is an illustration of acquiring a total distress time and a distress frequency according to a facial feature of a user of the proficiency detection system in FIG. 1.

FIG. 5 is a flow chart of a proficiency detection method performed by the proficiency detection system in FIG. 1.

### DETAILED DESCRIPTION

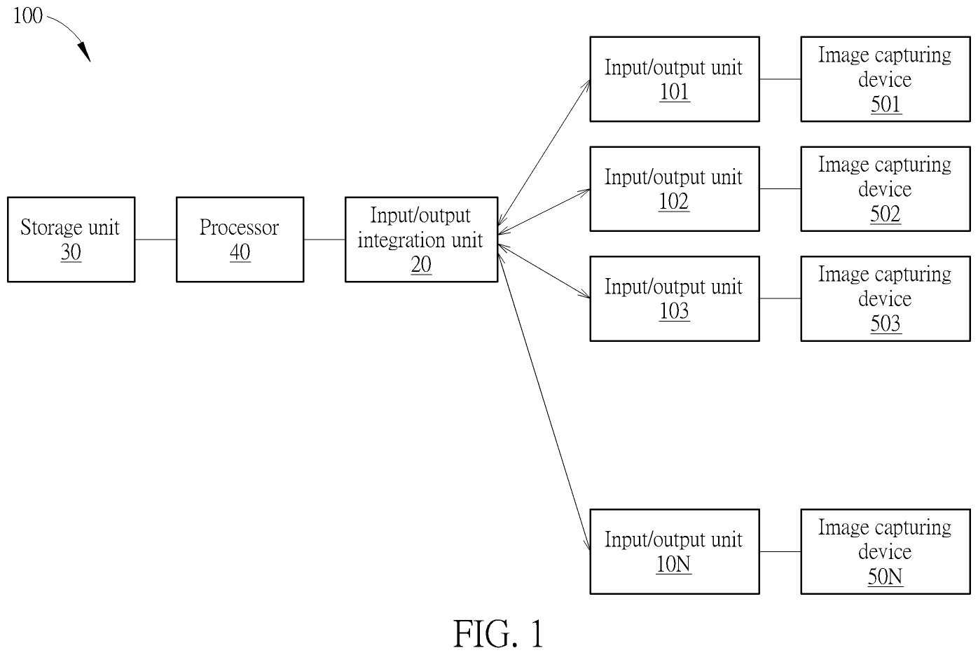

FIG. 1 is a block diagram of a proficiency detection system 100 according to a first embodiment of the present invention. The proficiency detection system 100 includes at least one input/output unit 101 to 10N, an input/output integration unit 20, a storage unit 30, and a processor 40. Each of the at least one input/output unit 101 to 10N can be a touch control screen device, such as an electronic whiteboard screen, a smartphone screen, or a computer screen. Each of the input/output units 101 to 10N can also be a composite system of a screen combined with a keyboard and a mouse. In other embodiments, the input/output units 101 to 10N can be electronic whiteboard screens for applying to a non-remote teaching process, or keyboards, mice, and screens connected to remote computers for a remote teaching process. N is a positive integer. The at least one input/output unit 101 to 10N is used for displaying a question and generating interactive data. The input/output integration unit 20 is coupled to the at least one input/output unit 101 to 10N for receiving and integrating the interactive data. For example, the input/output integration unit 20 can be wirelessly connected to the input/output units 101 to 10N through a network for receiving the interactive data of the input/output units 101 to 10N. Then, the interactive data can be integrated and displayed on an interface. The storage unit 30 is used for saving data. The storage unit 30 can be a memory or a hard disk for saving handwriting response status (i.e., such as an answering time, an idle time, a revision frequency) data. The processor 40 is coupled to the storage unit 30 and the input/output integration unit 20 for determining a proficiency of a user. In the proficiency detection system 100, the processor 40 can provide the question to the user through the at least one input/output unit 101 to 10N. The user can be a student. The processor 40 can set a scoring standard. Each of the at least one input/output unit 101 to 10N detects the handwriting response status of the user to the question. The input/output unit 101 to 10N can transmit information of the handwriting response status to the input/output integration unit 20. Then, the processor 40 generates a proficiency score according to the handwriting response status and the scoring standard through the input/output integration unit 20. The processor 40 can save information of the handwriting response status to the storage unit 30. Finally, the processor 40 can determine the proficiency of the user according to the proficiency score. As shown in FIG. 1, the proficiency detection system 100 can be applied to the remote teaching process. Each input/output unit can correspond to a user. In other words, the proficiency detection system 100 in FIG. 1 can support detecting the learning proficiency of N users.

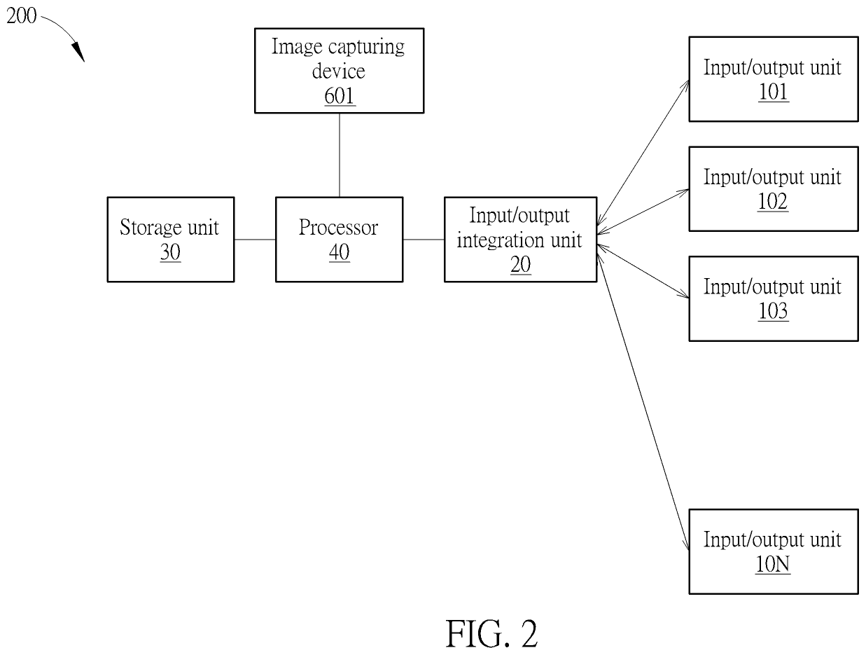

FIG. 2 is a block diagram of a proficiency detection system 200 according to a second embodiment of the present invention. For avoiding ambiguity, the proficiency detection system shown in FIG. 2 is called as the proficiency detection system 200 hereafter. As previously mentioned, the proficiency detection system of the present invention can be applied to the electronic whiteboards for the non-remote teaching process, or can be applied to the computers for the remote teaching process. For example, in FIG. 1, each of the input/output units 101 to 10N of the proficiency detection system 100 can be a composite system of a screen combined with a keyboard and a mouse. In FIG. 2, the input/output units 101 to 10N of the proficiency detection system 200 can be the electronic whiteboards for the non-remote teaching process. In other embodiments, the input/output units 101 to 10N, the storage unit 30, the input/output integration unit 20, and the processor 40 can be integrated into the electronic whiteboards. Further, an image capturing device can be coupled to the at least one input/output unit for detecting a handwriting response status of at least one user to the question. However, the number of electronic whiteboards and the number of users are not limited in the proficiency detection system 200. For example, the proficiency detection system 200 can introduce a plurality of electronic whiteboards including the input/output units 101 to 10N for a plurality of users. The proficiency detection system 200 can introduce a single electronic whiteboard for a plurality of users. Any reasonable hardware modification falls into the scope of the present invention.

In the proficiency detection systems 100 and 200, the learning proficiency of the user can be quantified. Therefore, the learning effectiveness can be tracked accurately and objectively. The learning proficiency of the user can be generated according to the handwriting response status of the user to the question. The proficiency detection systems 100 and 200 provide several quantified handwriting response statuses, as illustrated below. The processor 40 can use the at least one input/output unit 101 to 10N for acquiring an answering time of the user to the question. Further, the processor 40 can set standard answering time. In other words, the handwriting response status includes the answering time of the user to the question. The answering time of the user to the question can be defined as a time duration from a first time point of the user starting to answer the question to a second time point of the user finishing answering the question. Further, after the processor 40 compares the answering time of the user with the standard answering time, the processor 40 can generate a comparison result. Then, the processor 40 can generate the proficiency score according to the comparison result.

The processor 40 can use the at least one input/output unit 101 to 10N for acquiring an idle time of the user to the question. Further, the processor 40 can set a standard idle time. In other words, the handwriting response status includes the idle time of the user to the question. The idle time of the user can be defined as a time duration from a third time point of the user leaving a first triggering event to a fourth time point of the user entering a second triggering event. Further, after the processor 40 compares the idle time of the user with the standard idle time, the processor 40 can generate a comparison result. Then, the processor 40 can generate the proficiency score according to the comparison result.

The processor 40 can use the at least one input/output unit 101 to 10N for acquiring a revision frequency of the user to the question. Further, the processor 40 can set a standard revision frequency. In other words, the handwriting response status includes the revision frequency of the user. The revision frequency of the user can be defined as the number of revisions the user makes when answering the question. Further, after the processor 40 compares the revision frequency of the user with the standard revision frequency, the processor 40 can generate a comparison result. Then, the processor 40 can generate the proficiency score according to the comparison result.

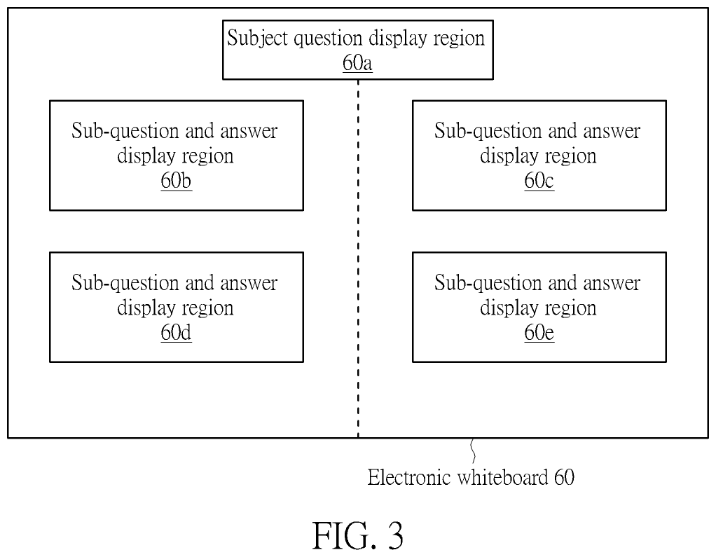

FIG. 3 is an illustration of display regions of an electronic whiteboard 60 of the proficiency detection system 200. For simplicity, a single electronic whiteboard 60 is introduced in FIG. 3. Further, as previously mentioned, the at least one input/output unit 101 to 10N, the storage unit 30, the input/output integration unit 20, and the processor 40 can be integrated into the electronic whiteboard 60. The electronic whiteboard 60 can display a plurality of regions. For example, the electronic whiteboard 60 can display a subject question display region 60a, and sub-question and answer display regions 60b to 60e. The electronic whiteboard 60 can be used for two users. For example, a user A can use the sub-question and answer display region 60b and the sub-question and answer display region 60d. A user B can use the sub-question and answer display region 60c and the sub-question and answer display region 60e. In practice, the sub-question and answer display regions 60b to 60e can be allocated in Table T1.

TABLE T1

| sub-question and | | |
|---|---|---|
| answer display region | User | Coordinates/(length, width) |
| 60b(for user A) | A | (10, 10)/(100, 50) |
| 60d(for user A) | A | (10, 60)/(100, 50) |
| 60c(for user B) | B | (130, 10)/(100, 20) |
| 60e(for user B) | B | (130, 60)/(100, 20) |

When the user A and the user B use the electronic whiteboard 60 for answering the question, the input/output integration unit 20 of the whiteboard 60 can acquire touching coordinates and timing of each event of the user A and the user B. For simplicity, all statuses of answering the question by the user A can be illustrated in Table T2.

TABLE T2

| Event | Type | User | Coordinates | Timing | Region |
|---|---|---|---|---|---|
| 1 | finger press | A | (xa, ya) | 0:00 | 60b |
| 2 | finger movement | A | (xb, yb) | 0:01 | 60b |
| 3 | finger removal | A | (xc, yc) | 0:30 | 60b |
| 4 | Erase | A | (xd1, yd1)- | 0:35 | 60b |
| | | | (xd2, yd2) | | |
| 5 | finger press | A | (xf, yf) | 0:50 | 60b |
| 6 | finger movement | A | (xg, yg) | 0:51 | 60b |
| 7 | finger removal | A | (xh, yh) | 1:30 | 60b |

Further, detections of the “answering time”, the “idle time”, and the “revision frequency” previously mentioned are illustrated below. For the answering time, the answering time can be defined as a time duration from a first time point of the user starting to answer the question (or a time point of generating the question, or a time point of finger press, at 0:00) to a second time point of the user finishing answering the question (i.e., a time point of finger removal, at 1:30). Therefore, the answering time is 90 seconds. For the idle time, the idle time can be defined as a time duration from a third time point of the user leaving a first triggering event to a fourth time point of the user entering a second triggering event. For example, the finger is removed from the whiteboard 60 at 0:30 (i.e., a first triggering event is removed). Then, the user A presses the finger at 0:50 (i.e., entering a second triggering event). Therefore, the idle time is 20 seconds. However, in other embodiments, the processor 40 can acquire a time length of a touch point staying on a pair of coordinates when the user answers the question. In other words, when the touch point stays on the pair of coordinates, it implies that the user is thinking about how to respond to the question. Therefore, the time length of the touch point staying on the pair of coordinates can be added to the idle time for improving detection accuracy. For the revision frequency, the revision frequency is defined as the number of revisions the user makes when answering the question. In Table 2, the processor 40 detects coordinates of the touching point of the user A is linearly moved from (xd1,yd1) to (xd2,yd2) at 0:35. Therefore, the revision frequency is one during 90 seconds (i.e., the answering time duration). Since the detection method of the proficiency detection system 100 is similar to the proficiency detection system 200, it is omitted here.

In the proficiency detection system 100 and the proficiency detection system 200, as previously mentioned, the image capturing device can be introduced for detecting the handwriting response status of the user to the question. For example, the image capturing device 601 can be introduced to the electronic whiteboard 60 of the proficiency detection system 200 for detecting a “facial feature”, “total distress time”, and “distress frequency” of the user for improving accuracy of quantifying the learning proficiency, as illustrated below.

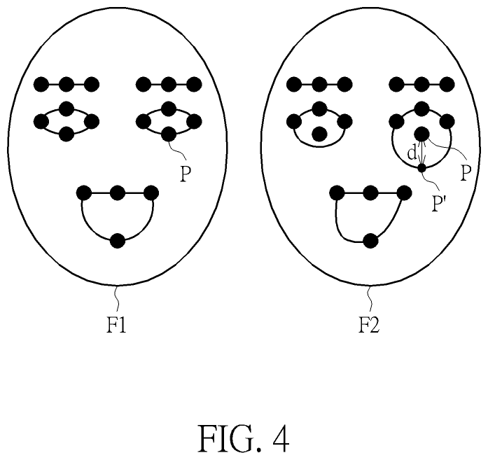

FIG. 4 is an illustration of acquiring a total distress time and a distress frequency according to a facial feature of a user of the proficiency detection system 100. As shown in FIG. 4, the image capturing device 601 can obtain an actual face image F1. Then, the processor 40 can obtain the facial features of the user in real-time when answering the question according to the actual face image F1. For example, the processor 40 can acquire all the coordinates of facial feature points of the user when answering the question according to the actual face image F1, such as coordinates of eyebrows, eyes, and a mouth, expressed as (cx1,cy1), (cx2,cy2), (cx3,cy3), . . . , (cxM,cyM). M is a positive integer. Further, the processor 40 can preset at least one agony facial reference point P′. The at least one agony facial reference point P′ corresponds to agony facial position coordinates. For example, the processor 40 can preset at least one agony facial reference image F2. The at least one agony facial reference image F2 can be previously saved in the storage unit 30. The processor 40 can set a plurality of agony facial position coordinates according to the at least one agony facial reference image F2, such as coordinates of eyebrows, eyes, and a mouth, expressed as (x1,y1), (x2,y2), (x3,y3), . . . , (xM,yM). Then, after the processor 40 acquires the plurality of facial position coordinates of the user according to the facial feature when the user answers the question, the processor 40 can count a total distress time when differences between the plurality of facial position coordinates of the user and the plurality of agony facial position coordinates are less than a threshold value while answering the question. For example, as previously mentioned, the plurality of facial position coordinates can be express as (cx1,cy1), (cx2,cy2), . . . , (cxM,cyM). The plurality of agony facial position coordinates can be expressed as (x1,y1), (x2,y2), (x3,y3), . . . , (xM,yM). Therefore, the processor can acquire similarity between the actual face image F1 and the agony facial reference image F2 according to the following equation:

Δ=|cx1−x1|+|cx2−x2|+|cx3−x3|+|cx4−x4| . . . +|cxM−xM|+|cy1−y1|+|cy2−y2|+|cy3−y3|+|cy4−y4| . . . +|cyM−yM|

Δ is denoted as a total difference between the plurality of facial position coordinates and the plurality of agony facial position coordinates. If Δ is smaller than the threshold, it implies that the actual face image F1 is similar to the agony facial reference image F2. When the actual face image F1 is similar to the agony facial reference image F2, the processor 40 counts the distress time. If Δ is greater than the threshold, it implies that the user is not in a distressed mood. Therefore, the processor 40 suspends to count the distress time.

Further, the processor 40 can generate a distress frequency according to the plurality of facial position coordinates and the plurality of agony facial position coordinates. Particularly, the processor 40 can increment the distress frequency whenever differences between the plurality of facial position coordinates of the user and the plurality of agony facial position coordinates are less than a threshold value while answering the question. In the previous embodiment, the answering time is 90 seconds. The total distress frequency is the number of A being smaller than the threshold during 90 seconds.

The proficiency detection system 100 and the proficiency detection system 200 can detect the “answering time”, the “idle time”, the “revision frequency”, the “total distress time”, and the “distress frequency”. Further, an administrator (i.e., a teacher) can preset a scoring standard. For example, the administrator can preset the “standard answering time”, the “standard idle time”, the “standard revision frequency”, the “standard distress time”, and the “standard distress frequency”, as shown in Table T3.

TABLE T3

| | standard | standard | standard | standard | standard |
|---|---|---|---|---|---|
| | answering | idle | revision | distress | distress |
| | time | time | frequency | time | frequency |
| Question | 10 | 2 | 3 | 2 | 3 |
| 1-1 | minutes | minutes | | minutes | |
| Question | 10 | 2 | 3 | 2 | 3 |
| 1-2 | minutes | minutes | | minutes | |
| Question | 10 | 2 | 3 | 2 | 3 |
| 1-3 | minutes | minutes | | minutes | |

In other words, when the answering time is greater than the standard answering time, it implies that the user is unskilled to answer the question. When the idle time is greater than the standard idle time, it implies that the user is unskilled to answer the question. When the revision frequency is greater than the standard revision frequency, it implies that the user is unskilled to answer the question. When the total distress time is greater than the standard distress time, it implies that the user is unskilled to answer the question. When the distress frequency is greater than the standard distress frequency, it implies that the user is unskilled to answer the question. Specifically, in the proficiency detection system 100 and the proficiency detection system 200, the learning proficiency of the user can be objectively quantified, as illustrated below.

$$proficiency score = \frac{answering time - standard answering time}{standard answering time} + \frac{idle time - standard idle time}{standard idle time} + \frac{revision frequency - standard revision frequency}{standard revision frequency} + \frac{total distress time - standard distress time}{standard distress time} + \frac{revision frequency - standard distress frequency}{standard distress frequency}$$

When the proficiency score is small, it implies that the learning proficiency of the user is satisfactory. When the proficiency score is large, it implies that the learning proficiency of the user is poor. Particularly, although the processor 40 can determine the proficiency score according to the “answering time”, the “idle time”, the “revision frequency”, the “total distress time”, and the “distress frequency”, the present invention is not limited to using aforementioned types for determining the proficiency score. For example, in other embodiments, the processor 40 can only use the “answering time”, the “idle time”, and the “revision frequency” for determining the proficiency score. Then, the processor 40 can update the proficiency score to generate an updated proficiency score according to the facial features, such as “total distress time” and “distress frequency”. In other embodiments, the processor 40 can select at least one detection type from the “answering time”, the “idle time”, the “revision frequency”, the “total distress time”, and the “distress frequency” for generating the proficiency score. Any reasonable detection method or technology modification falls into the scope of the present invention.

After the proficiency detection system 100 or the proficiency detection system 200 acquires the proficiency score, the processor 40 can analyze the proficiency of the user. Then, the administrator (i.e., the teacher) can use the processor 40 for updating the scoring standard according to the proficiency of the user. The updated scoring standard can be illustrated in Table T4.

TABLE T4

| | standard | standard | standard | standard | standard | |
|---|---|---|---|---|---|---|
| | answering | idle | revision | distress | distress | |
| | time | time | frequency | time | frequency | user |
| 1-1 | 3 | 30 | 1 | 1 | 1 | A |
| | minutes | seconds | | minutes | | |
| 1-1 | 3 | 30 | 2 | 2 | 2 | B |
| | minutes | seconds | | minutes | | |
| 1-1 | 6 | 60 | 3 | 3 | 3 | C |
| | minutes | seconds | | minutes | | |

In other words, under the same question, the administrator can acquire the learning efficiency of the users according to their learning proficiencies. Therefore, the administrator can dynamically adjust the scoring standard of the proficiency detection system for improving the reference value of the learning proficiency. Further, after the proficiency detection system 100 or the proficiency detection system 200 acquires the proficiency score, the processor 40 can analyze the proficiency of the user. Then, the administrator (i.e., the teacher) can use the processor 40 for updating the question according to the proficiency of the user.

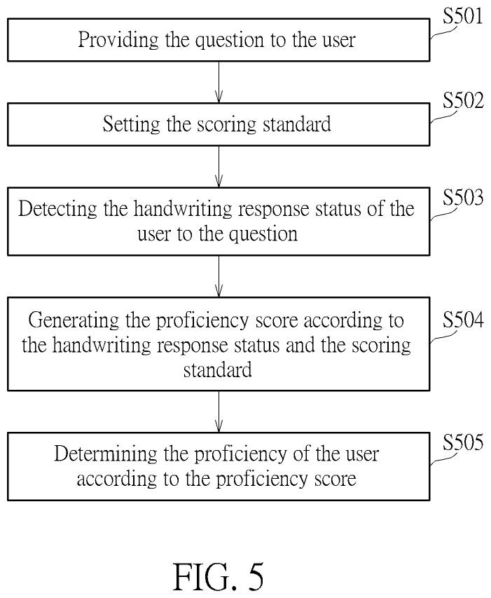

FIG. 5 is a flow chart of a proficiency detection method performed by the proficiency detection system 100. The proficiency detection method includes step S501 to step S505. Step S501 to step S505 are illustrated below.
step S501: providing the question to the user;
step S502: setting the scoring standard;
step S503: detecting the handwriting response status of the user to the question;
step S504: generating the proficiency score according to the handwriting response status and the scoring standard;
step S505: determining the proficiency of the user according to the proficiency score.

Details of step S501 to step S505 are previously illustrated. Therefore, they are omitted here. The proficiency detection system can generate a proficiency score of the user. Then, the proficiency detection system can determine the proficiency of the user according to the proficiency score. Since the proficiency of the user can be quantified, the administrator can dynamically adjust the scoring standard or the question for improving the detection reliability. Therefore, the learning efficiency of the user can be improved.

To sum up, the present invention discloses a proficiency detection method and a proficiency detection system capable of detecting learning proficiency of a user. The proficiency detection system provides a plurality of scoring standards. Then, the proficiency detection system can quantify the proficiency score according to a handwriting response status of the user to the question. The proficiency detection system can be applied to any educational software or hardware. An administrator can dynamically adjust at least one scoring standard or the question for improving the detection reliability. Therefore, the learning efficiency of the user can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A proficiency detection method comprising:
providing a question to a user;
setting a scoring standard;
detecting a handwriting response status of the user to the question;
generating a proficiency score according to the handwriting response status and the scoring standard; and
determining a proficiency of the user according to the proficiency score.

2. The method of claim 1, further comprising:
acquiring an answering time of the user to the question;
wherein the scoring standard comprises a standard answering time, the handwriting response status comprises the answering time of the user to the question, the answering time of the user to the question time of the user is a time duration from a first time point of the user starting to answer the question to a second time point of the user finishing answering the question, and the proficiency score is related to a comparison result generated by comparing the answering time of the user with the standard answering time.

3. The method of claim 1, further comprising:
acquiring an idle time of the user to the question;
wherein the scoring standard comprises a standard idle time, the handwriting response status comprises the idle time of the user to the question, the idle time of the user is a time duration from a third time point of the user leaving a first triggering event to a fourth time point of the user entering a second triggering event, and the proficiency score is related to a comparison result generated by comparing the idle time of the user with the standard idle time.

4. The method of claim 3, further comprising:
acquiring a time length of a touch point staying on a pair of coordinates when the user answers the question.

5. The method of claim 1, further comprising:
acquiring a revision frequency of the user to the question;
wherein the scoring standard comprises a standard revision frequency, the handwriting response status comprises the revision frequency of the user, the revision frequency of the user is number of revisions the user makes when answering the question, and the proficiency score is related to a comparison result generated by comparing the revision frequency of the user with the standard revision frequency.

6. The method of claim 1, further comprising:
detecting a facial feature of the user when the user answers the question;
updating the proficiency score to generate an updated proficiency score according to the facial feature; and
updating the proficiency of the user according to the updated proficiency score.

7. The method of claim 6, further comprising:
setting a plurality of agony facial position coordinates;
acquiring a plurality of facial position coordinates of the user according to the facial feature when the user answers the question; and
counting a total distress time when differences between the plurality of facial position coordinates of the user and the plurality of agony facial position coordinates are less than a threshold value while answering the question.

8. The method of claim 6, further comprising:
setting a plurality of agony facial position coordinates;
acquiring a plurality of facial position coordinates of the user according to the facial feature when the user answers the question; and
incrementing a distress frequency whenever differences between the plurality of facial position coordinates of the user and the plurality of agony facial position coordinates are less than a threshold value while answering the question.

9. The method of claim 1, further comprising:
analyzing the proficiency of the user; and
updating the scoring standard according to the proficiency of the user.

10. The method of claim 1, further comprising:
analyzing the proficiency of the user; and
updating the question according to the proficiency of the user.

11. A proficiency detection system comprising:
at least one input/output unit configured to display a question and generate interactive data;
an input/output integration unit coupled to the at least one input/output unit and configured to receive and integrate the interactive data;
a storage unit configured to save data; and
a processor coupled to the storage unit and the input/output integration unit;
wherein the processor provides the question to a user through the at least one input/output unit, the processor sets a scoring standard, the at least one input/output unit detects a handwriting response status of the user to the question, the at least one input/output unit transmits information of the handwriting response status to the input/output integration unit, the processor generates a proficiency score according to the handwriting response status and the scoring standard through the input/output integration unit, the processor saves information of the handwriting response status to the storage unit, and the processor determines a proficiency of the user according to the proficiency score.

12. The system of claim 11, wherein the processor uses the at least one input/output unit for acquiring an answering time of the user to the question, the processor sets standard answering time, the handwriting response status comprises the answering time of the user to the question, the answering time of the user to the question is a time duration from a first time point of the user starting to answer the question to a second time point of the user finishing answering the question, and the proficiency score is related to a comparison result generated by comparing the answering time of the user with the standard answering time.

13. The system of claim 11, wherein the processor uses the at least one input/output unit for acquiring an idle time of the user to the question, the processor sets a standard idle time, the handwriting response status comprises the idle time of the user to the question, the idle time of the user is a time duration from a third time point of the user leaving a first triggering event to a fourth time point of the user entering a second triggering event, and the proficiency score is related to a comparison result generated by comparing the idle time of the user with the standard idle time.

14. The system of claim 13, wherein the processor acquires a time length of a touch point staying on a pair of coordinates when the user answers the question.

15. The system of claim 11, wherein the processor uses the at least one input/output unit for acquiring a revision frequency of the user to the question, the processor sets a standard revision frequency, the handwriting response status comprises the revision frequency of the user, the revision frequency of the user is number of revisions the user makes when answering the question, and the proficiency score is related to a comparison result generated by comparing the revision frequency of the user with the standard revision frequency.

16. The system of claim 11, further comprising:
an image capturing device coupled to the at least one input/output unit or the processor;
wherein the processor uses the image capturing device for detecting a facial feature of the user when the user answers the question, the processor updates the proficiency score to generate an updated proficiency score according to the facial feature, and the processor updates the proficiency of the user according to the updated proficiency score.

17. The system of claim 16, further comprising:
an image capturing device coupled to the at least one input/output unit or the processor;
wherein the processor sets a plurality of agony facial position coordinates, the processor acquires a plurality of facial position coordinates of the user according to the facial feature when the user answers the question, and the processor counts a total distress time when differences between the plurality of facial position coordinates of the user and the plurality of agony facial position coordinates are less than a threshold value while answering the question.

18. The system of claim 16, further comprising:
an image capturing device coupled to the at least one input/output unit or the processor;
wherein the processor sets a plurality of agony facial position coordinates, the processor acquires a plurality of facial position coordinates of the user according to the facial feature when the user answers the question, and the processor increments a distress frequency whenever differences between the plurality of facial position coordinates of the user and the plurality of agony facial position coordinates are less than a threshold value while answering the question.

19. The system of claim 11, wherein the processor analyzes the proficiency of the user, and the processor updates the scoring standard according to the proficiency of the user.

20. The system of claim 11, wherein the processor analyzes the proficiency of the user, and the processor updates the question according to the proficiency of the user.
